(19) United States
(12) Patent Application Publication
(10) Pub. No.: US 2006/0098383 A1
(43) Pub. Date: May 11, 2006

(54) Electrical component and an assembly comprising said component

(76) Inventor: Hubertus Goesmann, Nattheim (DE)

Correspondence Address: FISH & RICHARDSON PC, P.O. BOX 1022, MINNEAPOLIS, MN, 55440-1022, US

(21) Appl. No.: 10/528,314

(22) PCT Filed: Sep. 29, 2003
(86) PCT No.: PCT/DE03/03241

§ 371 Date: Nov. 14, 2005

(30) Foreign Application Priority Data
Sep. 27, 2002 (DE) 102-45-131.1
Dec. 9, 2002 (DE) 102-57-441.3

(51) Int. Cl. H01G 2/00

(52) U.S. Cl. 361/272

(57) ABSTRACT

The invention concerns an electrical component (3), with an electrical connection (1, 1a, 1b), which contains aluminum in its surface, in which a contact area (2) of the aluminum-containing surface has been made solderable. The component has the advantage that no flat contact surfaces are necessary due to the soldering, and the ohmic resistance of the contact can be reduced.

The invention concerns an electrical component with electrical connections containing aluminum on the surface. In addition, the invention concerns a device including said component.

Components of the type described above are known, in which electrical connections made of aluminum are provided. Such components can include capacitors. In particular, aluminum-electrolyte capacitors, as well as electrochemical double-layer capacitors are possible. In electrical connections of this type, electrical connections made of aluminum are preferentially used, because aluminum is resistant to the aggressive chemical fluids commonly found in capacitors of this type. Thus, for example, aluminum-electrolyte capacitors contain chemical substances that chemically attack many metals commonly used as electrical connections. The material aluminum has the advantage of forming an aluminum oxide passivation layer on its surface, and this passivation layer protects the aluminum from further damage by an aggressive fluid.

The known art components, however, have the disadvantage that, due to the passivation layer on the surface of the aluminum connections, electrical contacting of the components is more difficult. The aluminum oxide passivation layer is an electrical insulator; thus, when contacting electrical conductors or other electrical components, high transitional resistances occur that are generally undesirable.

Thus, the present invention seeks to disclose an electrical component with improved electrical contactability.

This is achieved by a component according to patent claim 1. Advantageous embodiments of the component, as well as a device including said component are contained in the other patent claims.

An electrical component is disclosed with electrical connections containing aluminum on the surface. The aluminum-containing surface is made solderable in a contact area.

Making the aluminum-containing surface solderable has the advantage that an aluminum oxide passivation layer can no longer be formed, because solderable metals do not form such a passivation layer.

Accordingly, the invention has an aluminum-containing surface of the electrical connections that is coated with a solderable material in a contact area. Solderable materials include, in particular, those materials that do not form a passivation layer. Nickel or copper, for example, could be used as solderable material.

In one embodiment of the component, the aluminum-containing surface of the connections is chemically nickel-plated. The chemical nickel plating has the advantage that it can be carried out simply in order to place a solderable metal on the surface of the aluminum. The nickel plating of the electrical connection can be achieved, for example, by a procedure disclosed in U.S. Pat. No. 4,196,061, which disclosures are expressly incorporated hereinto by reference.

Furthermore, it is possible to copper plate the electrical connections. Copper plating can be carried out chemically as well.

Galvanic coating of the electrical connections does not come into consideration to the same extent due to the electrically insulating passivation layer on the aluminum.

The passivation layer on the surface of the aluminum is formed in normal environmental conditions without any particular additional measures.

In order to further improve the solderability of the electrical connections, one embodiment of the component provides for at least partial tin plating of the surface of the electrical connections that is coated with the solderable metal.

An additional advantage is obtained by making the contact area of the surface of the electrical connections solderable. The aluminum covered by the passivation layer, which forms the material of the electrical connections in known art components, is normally not solderable; thus, in known art components, contact must be made by means of clamping, riveting, or screwing. In order to obtain a sufficiently low contact resistance in contacts of this type, it is necessary for the electrical connections in the contact area to have as flat a surface as possible, because the mechanical contact between various contact elements or between the electrical connection of the component and, e.g., a screw creating a screw contact will otherwise only be present at certain points. A flat surface of the known art electrical connections allows for a two-dimensional mechanical, as well as electrical contact, which, however, in many cases cannot satisfactorily reduce the ohmic resistance.

Because the component disclosed herein provides for solderable electrical connections, it is no longer necessary to provide a flat surface for the electrical connections in the contact area, thus reducing the technological expense for the manufacture of the electrical contacts. The component disclosed herein allows for forms of electrical connections that deviate from an even surface without dispensing with a sufficiently low ohmic resistance of the contact. In particular, it is possible to use electrical connections that are bent or have a rough surface.

The electrical component disclosed herein can be, in particular, an aluminum-electrolyte capacitor. In such capacitors, preferably, all metals used are aluminum. Thus, for example, an aluminum-electrolyte capacitor is particularly advantageous, in which the bucket-shaped housing, the cover closing off the housing, and the electrical contacts, as well as the anode and cathode foils that form the actual capacitor, are made of the material aluminum. The aluminum has the property of forming a thin insulating passivation layer on the surface, which, in the capacitor, allows for very high capacities to be set.

It is also advantageous for the electrical component disclosed herein to be an electrochemical double-layer capacitor, for which similar statements to those made above in regard to the aluminum-electrolyte capacitor generally hold true. One important difference is that the electrodes in an electrochemical double-layer capacitor is formed, for example, using carbon-containing fabric or carbon-layered aluminum foil.

In particular, the component disclosed herein can contain a chemically active fluid, in particular, a chemically aggressive fluid, as is commonly contained in electrochemical double-layer capacitors or aluminum-electrolyte-capacitors.

Moreover, a device containing the electrical component is disclosed, in which at least one connection is soldered with an electrical conductor. This device has the advantage that the soldering of the connection with an electrical connector allows for contact with the component with a low ohmic resistance.

The connection can also be connected with an additional electrical component, which, for example, can be an electrical component as disclosed herein or another electrical component.

In addition, a device is disclosed in which the connections of two electrical components are each soldered together with a connector, which connects the components in an electrically conductive manner. In this way, it is possible to create an electrically conductive connection between two components as herein disclosed in a simple fashion.

A further embodiment of the device can provide that the connections of one or more components are soldered together with a printed circuit board. In this case, it is possible, in particular, to solder the connections of the components together with strip conductors of the printed circuit board.

The invention is described in greater detail below with exemplary embodiments and related illustrations.

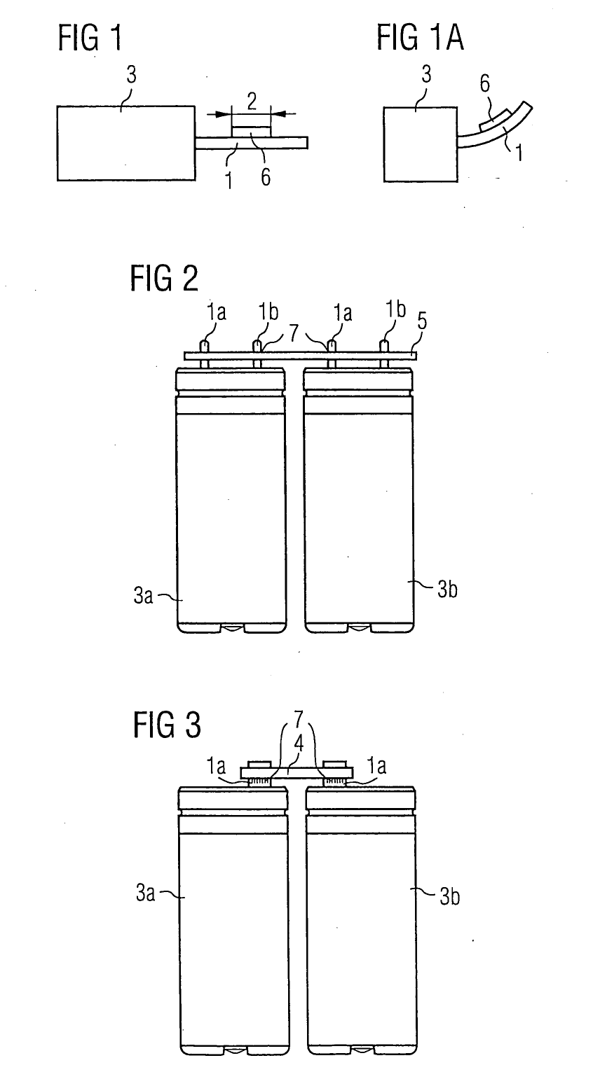

FIG. 1 shows, by way of example, an electrical component in a schematic lateral view.

FIG. 1A shows, by way of example, a further electrical component in lateral view.

FIG. 2 shows, by way of example, a combination of two components on a printed circuit board.

FIG. 3 shows, by way of example, the electrical connection between two components.

FIG. 1 shows an electrical component 3, which includes an electrical connection 1. The electrical connection 1 contains aluminum on its surface. However, it can also be manufactured completely of aluminum. The electrical connection 1 can also run partially through the inside of the electrical component 3. In a contact area 2, the electrical connection 1 is provided with a nickel layer 6. This nickel layer 6 can be applied, for example, by chemical nickel plating of the contact area 2. However, it is also possible to extend the nickel layer 6 beyond the contact area 2. This has the advantage that no special means need be used in the process of nickel plating in order to prevent nickel plating of the areas of the surface of the electrical connection 1 that are not part of the contact area 2. For example, it would be possible to nickel plate the entire part of the connection 1 located outside of the electrical component 3.

When nickel plating the electrical connection 1, or generally when making the electrical connection 1 solderable, it is generally possible to proceed in two different orders. When proceeding in the first order, the electrical component 3 with the electrical connection 1 is first manufactured, followed by making the electrical connection 1 solderable. In another procedure, the electrical connection 1 can first be made solderable, followed by the assembly of electrical connection 1 and electrical component 3.

FIG. 1A shows an electrical component according to FIG. 1, in which, in contrast to FIG. 1, the electrical connection 1 has a clear upward curvature. This is intended to show that the surface of the electrical connection 1 can deviate from an even surface without detriment to the ohmic contact of the electrical connection between the electrical component 3 and a conductor or other components.

FIG. 2 shows two different electrical components 3a, 3b, which are connected with one another in an electrically conductive fashion via a printed circuit board 5. Here, the electrical connections 1a, 1b of each of the electrical components 3a, 3b are soldered together with electrically conductive strip conductors of the printed circuit board 5. Two soldered connections 7 are formed, which can be created, for example, by flow soldering. Possible printed circuit boards include a copper-laminated conductor plate.

FIG. 3 shows a further embodiment of a device disclosed herein. It provides for two electrical components 3a, 3b. The electrical component 3a has an electrical connection 1a. Electrical component 3b also has an electrical connection 1a. It further provides for a connector 4, which can be, for example, a copper plate or a nickel-plated aluminum plate. The connector 4 is soldered together with the electrical connection 1a of the electrical component 3b. The connector 4 is soldered together at its other end with the electrical connection 1a of the electrical component 3b. This creates an electrically conductive connection between both electrical components 3a, 3b, which has a very low ohmic resistance and, therefore, high quality.

In closing, it should be noted that the invention disclosed herein is not limited to electrolyte capacitors or chemical double-layer capacitors. Rather, the invention can be applied to all components that have electrical connections with surfaces that contain aluminum. Thus, for example, it is also possible that the electrical connections 1, 1a, 1b are not made of pure aluminum, but rather that the aluminum is in the form of an alloy. Moreover, it is also possible that the electrical connections 1, 1a, 1b can consist of another material internally than on the surface.

1. An electrical component comprising:
an electrical connection comprising aluminum, the electrical connection comprising a contact area that is solderable.

2. The electrical component of claim 1, wherein the contact area comprises a surface that is chemically plated with nickel.

3. The electrical component of claim 2, wherein the contact area is at least partially plated with tin.

4. The electrical component of claim 1, wherein a surface of the contact area is uneven.

5. An electrolytic capacitor comprising the electrical component of claim 1.

6. An electrochemical double-layer capacitor comprising the electrical component of claim 1.

7. The electrical component of claim 1, further comprising a chemically aggressive fluid.

8. A device comprising:
an electrical component according to claim 1; and
an electrical conductor;
wherein the electrical connection is soldered to the electrical conductor.

9. The device of claim 8, further comprising:
a second electrical component;
wherein the electrical conductor is soldered to an electrical connection on the second electrical component.

10. The device of claim 9, wherein the electrical conductor is part of a printed circuit board.

11. The device of claim 9, wherein the electrical conductor comprises a single conductor with a low resistance that connects electrical connections of the first electrical component to electrical connections of the second electrical component.

12. The device of claim 8, wherein the electrical conductor comprises a conductor plate.

13. An electrical component comprising:
a housing; and
an electrical connection that is partly within the housing, the electrical connection comprising aluminum and a layer of nickel on top of the aluminum, the layer of nickel defining a contact area.

14. The electrical component of claim 13, wherein the layer of nickel comprises chemically-plated nickel.

15. The electrical component of claim 13, wherein at least part of the electrical connection is curved.

16. The electrical component of claim 13, wherein the electrical connection comprises a surface that is plated with the aluminum.

17. The electrical component of claim 13, wherein the electrical connection is solid aluminum.

18. An apparatus comprising:
a first electrical component comprising a first electrical connection, the first electrical connection comprising aluminum and a first layer of nickel on top of the aluminum, the first layer of nickel comprising a first contact area;
a second electrical component comprising a second electrical connection, the second electrical connection comprising aluminum and a second layer of nickel on top of the aluminum, the second layer of nickel comprising a second contact area; and
a connector that electrically connects to the first contact area and to the second contact area.

19. The apparatus of claim 18, wherein:
the first electrical component comprises a third electrical connection, the third electrical connection comprising aluminum and a third layer of nickel on top of the aluminum, the third layer of nickel comprising a third contact area;
the second electrical component comprises a fourth electrical connection, the fourth electrical connection comprising aluminum and a fourth layer of nickel on top of the aluminum, the fourth layer of nickel comprising a fourth contact area; and
the connector electrically connects to the third contact area and to the fourth contact area.

20. The apparatus of claim 18, wherein the connector comprises electrically-conductive strip connectors of a printed circuit board.
